(19) United States
(12) Patent Application Publication
(10) Pub. No.: US 2008/0043713 A1
(43) Pub. Date: Feb. 21, 2008

(54) Communication System, Data Retransmission Control Method Thereof, and Wireless Transmitting/Receiving Apparatus Used Therein

(76) Inventor: Masahiro Komatsu, Tokyo (JP)

Correspondence Address: SCULLY SCOTT MURPHY & PRESSER, PC, 400 GARDEN CITY PLAZA, SUITE 300, GARDEN CITY, NY, 11530, US

(21) Appl. No.: 10/586,461

(22) PCT Filed: Jan. 14, 2005
(86) PCT No.: PCT/JP05/00725

§ 371 Date: Feb. 26, 2007

(30) Foreign Application Priority Data
Jan. 14, 2004 (JP) 2004-006183

(51) Int. Cl. H04J 3/24

(52) U.S. Cl. 370/349

(57) ABSTRACT

In a data retransmission system, wherein when a response signal (ACK/NACK) from a receiving end is NACK in response to a block data transmitted from a transmitting end, the block data is retransmitted, the transmission efficiency is improved by avoiding unnecessary retransmission of the block data. There is provided a packet composition monitor part (26) that determines that correct data block cannot be received even when the maximum number of retransmissions has been reached in a packet composition part (24) at the data receiving end. For another block data including only the packet data as included in the foregoing block data, a control information producing circuit (34) transmits an ACK signal, whether or not the reception has been performed without any errors, thereby eliminating occurrence of retransmission. In this way, unnecessary block data retransmission can be avoided to improve the transmission efficiency.

### TECHNICAL FIELD

The present invention relates to a communication system, a data retransmission control method thereof, and a wireless transmitting/receiving apparatus for use therein, and particularly to an improvement in a wireless communication system for transmitting/receiving data in block units by means of a wireless communication system.

### BACKGROUND ART

Various transmission control functions are widely used in data transmission for realizing reliable data communication. These functions include, for example, retransmission control, and the functions of acknowledge control, and error control. Wireless communication using radio as a communication medium indispensably requires means for recovering errors occurring in a transmission path, in order to keep up with changes in the wireless environment. This problem is typically solved by using, for example, the FEC (Forward Error Correction)method in which an error is corrected at the receiving end by giving redundancy to data, the ARQ (Automatic Repeat reQuest) method in which errored block data is detected and retransmitted, and the hybrid ARQ method combining these two methods. In these types of error control, transmitted data is converted into fixed-length blocks before transmission, and reliability in the wireless section is ensured by using control techniques such as retransmission control, acknowledge control, error control, and the like.

A description will be made on a conventional wireless communication apparatus for the ease of comprehension of the present invention.

FIG. 5 is a block configuration diagram principally showing functions of a data conversion part 20 in a conventional wireless communication apparatus. As shown in FIG. 5, the data conversion part 20 includes a terminal interface 21, a memory 22, a packet data decomposition part 23, a packet composition part 24, and a wireless interface 25. The terminal interface 21 has a function to connect a data terminal 10 which transmits packet data to be transmitted or receives received packet data. The memory 22 temporarily stores packet data. The packet data decomposition part 23 has a function to divide the packet data stored in the memory 22 into a plurality of block data and operates during data transmission.

The packet composition part 24 has a function to compose normally received block data as packet data, and the composed packet data is stored in the memory 22. The packet composition part 24 operates during data reception. The wireless interface 25 has a data transmission function to transmit blocked transmission data, and a data reception function to receive blocked data, and performs data transmission via a wireless communication part 30.

FIG. 6 shows an example of blocking by the packet data decomposition part 23 described above. An IP (Internet Protocol) packet which is a variable-length packet data transmitted by the data terminal 10 is blocked into fixed-length block data. The delimiters between the IP packets do not coincide with the delimiters between the block data. Therefore, one IP packet may be divided into a plurality of block data, or one block data may include a plurality of IP packets. If an IP packet is not long enough to fill one block data and the subsequent IP packet has not arrived yet, the remaining space of the block data is filled with dummy data.

The packet composition part 24 produces IP packets from block data. IP packets are an example of packet data, and the term “packet data” means a group of data, such as one file of data, image data corresponding to one image, or one record, which is exchanged with a terminal. The packet composition part 24 performs processing to compose IP packets from block data, namely the reverse processing to that indicated by the arrows in FIG. 6.

FIG. 7 is a block diagram illustrating in detail the data reception function (RX) among the functions of the wireless communication part 30 shown in FIG. 5. The data reception end 30RX of the wireless communication part 30 has a data conversion interface 31, a memory 32, a reception circuit 33, a control information generating circuit 34, and a control information transmission circuit 35. The data conversion interface 31 has a function to connect the data conversion part 20 which transmits block data to be transmitted or receives received block data. The memory 32 temporarily stores received block data. The reception circuit 33 has a function to receive block data transmitted from a transmission part of a wireless communication part at the other end (see FIG. 8).

The control information generating circuit 34 determines whether the received block data has been received correctly or not. When the received block data has been received correctly, the control information generating circuit 34 generates a reception acknowledge signal (ACK signal) indicating the successful reception. When the reception has been failed, the control information generating circuit 34 generates a negative acknowledge signal (NACK signal) indicating the reception failure. The control information transmission circuit 35 transmits the ACK/NACK signal incorporated in control information to the wireless apparatus at the other end.

FIG. 8 is a block configuration diagram illustrating in detail the data transmission function among the functions of the wireless communication part 30 shown in FIG. 5. The data transmission end 30TX of the wireless communication part 30 has a data conversion interface 41, a memory 42, a control information reception circuit 43, a transmission control circuit 44, and a transmission circuit 45. The data conversion interface 41 has a function to connect the data conversion part 20 which transmits block data to be transmitted or receives received block data. The memory 42 temporarily stores block data to be transmitted.

The control information reception circuit 43 and the transmission control circuit 44 perform control to retransmit errored block data. The control information reception circuit 43 receives control information transmitted by a wireless apparatus at the other end and extracts an ACK/NACK signal therefrom. The transmission control circuit 44 issues an instruction in accordance with the ACK/NACK signal. Specifically, in case of the ACK signal, the transmission control circuit 44 issues an instruction to the transmission circuit 45 to transmit new block data. Whereas, in case of the NACK signal, the transmission control circuit 44 issues an instruction to the transmission circuit 45 to retransmit the block data. If the ACK/NACK signal is discarded due to transmission error, the transmission control circuit 44 issues an instruction to retransmit corresponding block data. In response to the instruction from the transmission control circuit 44, the transmission circuit 45 transmits new block data or the block data to be retransmitted.

When data is exchanged bidirectionally with a terminal, the data transmission part 30TX and the data reception part 30RX are included together in a single wireless communication part 30. The ACK/NACK signal may be notified by various methods, such as by notifying the same for each block data, by notifying the same for each frame or each of larger units, or by subdividing the block data into smaller units and notifying the same for each of these smaller units. Systems for notifying the ACK/NACK signal by these methods are well known in the prior arts (see Japanese Laid-Open Patent Publication Nos. 2000-216812 and 2001-168907).

The communication system described above has a problem in that the delimiters of the packet data do not coincide with the delimiters of the block data. Therefore, even when it has been proved that correct block data cannot be received after a predetermined number of times, or the maximum number of retransmissions and composition of packet data is not possible, the receiving end still tries to receive other block data composing the packet data. This means that, the receiving end tries to receive other block data which follows the block that could not be received correctly and contains only data in the same packet as the foregoing block. If the other block data is not received correctly, it is retransmitted. This causes unnecessary transmission and reception of block data, constituting one of the factors deteriorating the transmission efficiency of the wireless communication employing ARQ.

### DISCLOSURE OF THE INVENTION

It is therefore an object of the present invention to provide a communication system, a data retransmission control method thereof, and a wireless transmitting/receiving apparatus for use in the data retransmission system, which is designed to retransmit block data when receiving an NACK signal from the receiving end in response to transmission of block data from the transmitting end, and capable of avoiding unnecessary retransmission of block data and improving the transmission efficiency of the data retransmission system.

The present invention provides a wireless communication system which is designed such that a transmitting end transmits packet data in block units; a receiving end transmits, to the transmitting end, a reception acknowledge signal when receiving the data successfully, whereas transmitting a negative acknowledge signal when not so; and the transmitting end retransmits data based on the negative acknowledge signal. The wireless communication system is characterized by including, at the receiving end thereof, monitoring means for detecting that correct block data cannot be received even when a predetermined number of retransmissions of the block data is reached; and means for transmitting a reception acknowledge signal for other block data containing, as packet data, only packet data that belongs to the same packet as the packet contained in the block data detected by the monitoring means.

The present invention further provides another type of wireless communication system which is also designed such that a transmitting end transmits packet data in block units; a receiving end transmits, to the transmitting end, a reception acknowledge signal when receiving the data successfully, whereas transmitting a negative acknowledge signal when not so; and the transmitting end retransmits data based on the negative acknowledge signal, but is characterized by including, at the receiving end thereof, means for detecting that correct block data cannot be received even when a predetermined number of retransmissions of the block data is reached and giving a notification to that effect to the transmitting end; and, at the transmitting end, transmission control means for performing control to inhibit transmission of block data containing, as packet data, only packet data that belongs to the same packet as that contained in the block data, in response to the notification.

The present invention provides a data retransmission control method for a wireless communication system in which a transmitting end transmits packet data in block units; a receiving end transmits, to the transmitting end, a reception acknowledge signal when receiving the data successfully, whereas transmitting a negative acknowledge signal when not so; and the transmitting end retransmits data based on the negative acknowledge signal. The data retransmission control method is characterized by including, at the receiving end, a monitoring step of detecting that correct block data cannot be received even when a predetermined number of retransmissions of the block data is reached; and a step of transmitting a reception acknowledge signal for other block data containing, as packet data, only packet data that belongs to the same packet as the packet contained in the block data detected by the monitoring means.

The present invention further provides another data retransmission control method also for a wireless communication system in which a transmitting end transmits packet data in block units; a receiving end transmits, to the transmitting end, a reception acknowledge signal when receiving the data successfully, whereas transmitting a negative acknowledge signal when not so; and the transmitting end retransmits data based on the negative acknowledge signal, but is characterized by including, at the receiving end, a step of detecting that correct block data cannot be received even when a predetermined number of retransmissions of the block data is reached and giving a notification to that effect to the transmitting end; and, at the transmitting end, a transmission control step of performing control to inhibit transmission of block data containing, as packet data, only packet data that belongs to the same packet as that contained in the block data, in response to the notification.

The present invention provides a wireless receiving apparatus which transmits, to a transmitting end, a reception acknowledge signal when block data transmitted by the transmitting end while dividing packet data into blocks is received successfully, whereas, when not so, transmits a negative acknowledge signal to receive retransmission of the data from the transmitting end based on the negative acknowledge signal, and is characterized by including: monitoring means monitoring means for detecting that correct block data cannot be received even when a predetermined number of retransmissions of the block data is reached; and means for transmitting a reception acknowledge signal for other block data containing, as packet data, only packet data that belongs to the same packet as the packet contained in the block data detected by the monitoring means.

The present invention further provides another type of wireless receiving apparatus which transmits, to a transmitting end, a reception acknowledge signal when block data transmitted by the transmitting end while dividing packet data into blocks is received successfully, whereas, when not so, transmits a negative acknowledge signal to receive retransmission of the data from the transmitting end based on the negative acknowledge signal, and is characterized by including: means for detecting that correct block data cannot be received even when a predetermined number of retransmissions of the block data is reached and giving a notification to that effect to the transmitting end.

The present invention provides a wireless transmitting apparatus which transmits packet data while dividing the same into blocks, and receives transmission of a reception acknowledge signal when the receiving end has successfully received the block data, whereas, when not so, receives a negative acknowledge signal and retransmits data based on the negative acknowledge signal, and is characterized by including: transmission control means which, when receiving from the receiving end a notification indicating that correct block data cannot be received even when a predetermined number of retransmissions of the block data is reached, performs control to inhibit transmission of block data containing, as packet data, only packet data that belongs to the same packet as that contained in the block data.

A description will now be made on operation of the present invention. The packet composition part at the data receiving end is provided with the packet composition monitor part for detecting that correct block data cannot be received even when the maximum number of retransmissions is reached, so that retransmission is inhibited for other block data containing only packet data contained in the block data by transmitting an ACK signal regardless of whether the reception was successful or not.

Alternatively, the packet composition part is provided with a packet composition monitor part detecting that correct block data cannot be received even when the maximum number of retransmissions is reached, and a number of packet data contained in the block data is notified to the other end of communication as control information to inhibit transmission of block data containing the packet data, or block data is reproduced while discarding the packet data for preventing the transmission of such packet data.

The present invention provides an effect of reducing or eliminating unnecessary transmission/reception of block data, and thus preventing the deterioration of transmission efficiency in wireless communication employing ARQ.

### BRIEF DESCRIPTION OF THE DRAWINGS

FIG. 1 is a block diagram showing a data receiving end (RX) according to a first embodiment of the present invention;

FIG. 2 is a block diagram showing a data receiving end (RX) according to a second embodiment of the present invention;

FIG. 3 is a block diagram showing a data transmitting end (TX) according to the second embodiment of the present invention;

FIG. 4 is a block diagram showing a data transmitting end (TX) according to a third embodiment of the present invention;

FIG. 5 is a block diagram illustrating a data conversion part in a conventional wireless communication apparatus;

FIG. 6 is a diagram illustrating a correspondence relationship between IP packet data and block data;

FIG. 7 is a block diagram illustrating a data receiving end (RX) in a conventional wireless communication apparatus; and

FIG. 8 is a block diagram illustrating a data transmitting end (TX) in a conventional wireless communication apparatus.

### BEST MODE FOR CARRYING OUT THE INVENTION

Embodiments of the present invention will be described in detail with reference to the drawings.

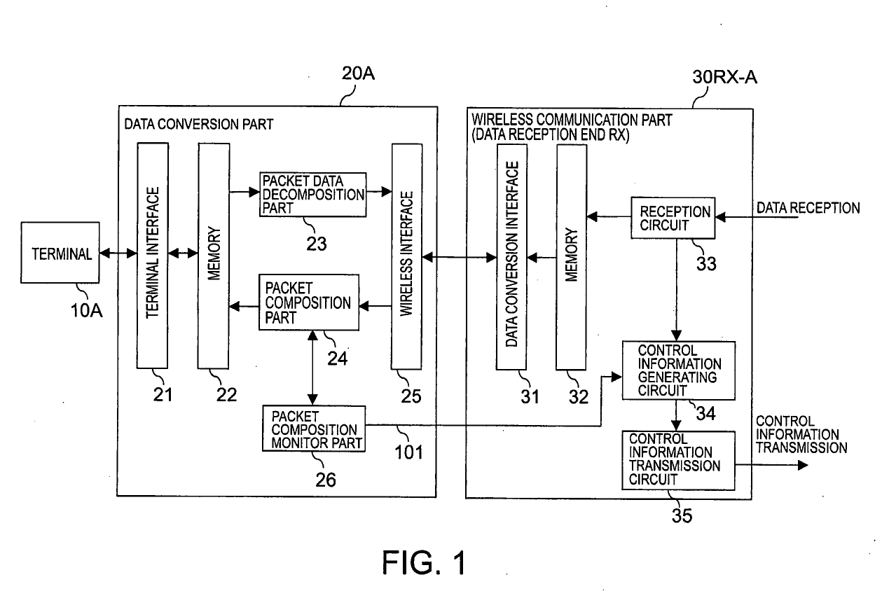

FIG. 1 is a functional block diagram illustrating a first embodiment of the present invention.

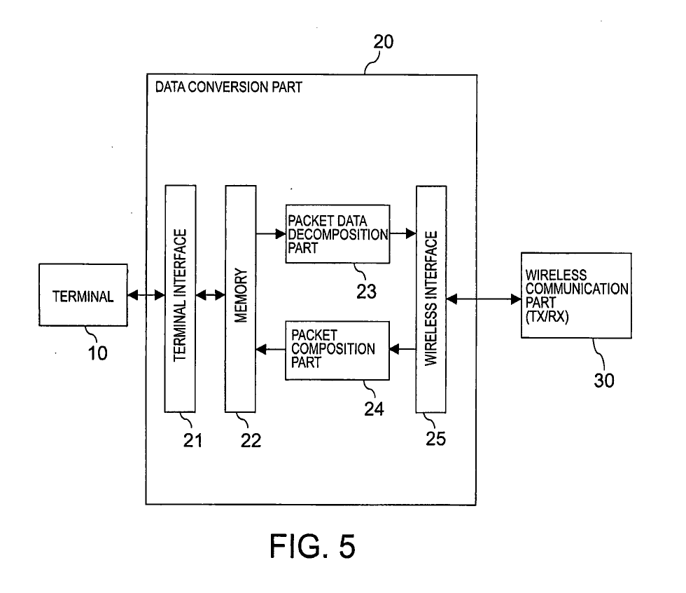

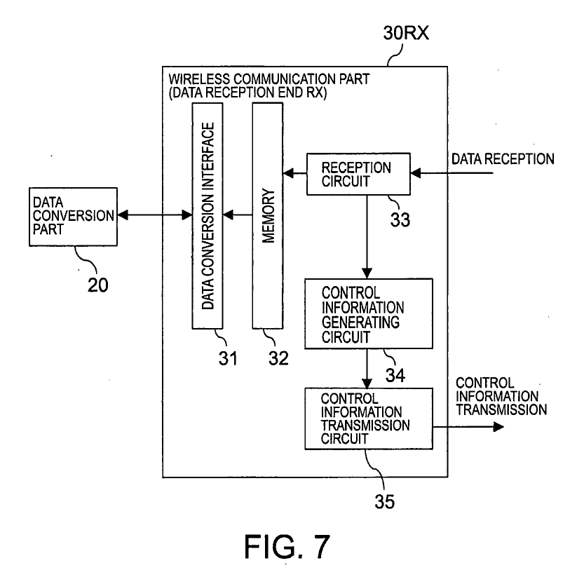

FIG. 1 shows function blocks of a data conversion part 20A and of a data reception part 30RX-A of a wireless communication part in a wireless communication apparatus. The data transmission part of the wireless communication part is omitted in FIG. 1. FIG. 1 corresponds to FIG. 5 and FIG. 7 showing prior art examples, and same reference characters are used to designate corresponding parts.

The data conversion part 20A has a packet composition monitor part 26 provided therein. An output 101 of the packet composition monitor part 26 is input to a control information generating circuit 34 of the data reception part 30RX-A of the wireless communication part. The other configurations are similar to those of FIG. 5 and FIG. 7, and thus the description thereof is omitted. The reference numeral 10A indicates a terminal connected to the data conversion part 20A.

When the packet composition part 24 cannot receive correct block data even when the maximum number of retransmissions is reached, the packet composition monitor part 26 detects this fact and stores packet data contained in this block data. The packet composition monitor part 26 then gives an instruction to a control information generating circuit 34 in the data receiving end 30RX-A of the wireless communication part to transmit an ACK signal for other block data containing only packet data belonging to the same packet, regardless of whether such block data has been received correctly or not.

More specifically, when the packet composition part 24 cannot receive correct block data even when the maximum number of retransmissions is reached, a packet number of the packet contained in the block data is extracted from the block data stored in the memory, and the packet number is stored. When detecting that correct block data cannot be received even when the maximum number of transmissions is reached, the packet composition monitor part 26 gives an instruction to the control information generating circuit 34 to transmit an ACK signal in response to reception of block data received subsequently, regardless of success or failure of the reception, if the packets contained in the block data include only packets having the same packet number as the packet number stored previously.

When instructed to transmit an ACK signal, the control information generating circuit 34 generates an ACK signal regardless of whether reception from the packet composition monitor part 26 was successful or not. Otherwise, the control information generating circuit 34 determines whether the received block data has been received correctly or not, and generates an ACK signal if it has been received correctly, whereas generates an NACK signal if it has not been received correctly. The control information transmission circuit 35 then transmits the ACK or NACK signal generated by the control information generating circuit 34 to a wireless apparatus at the other end (not shown) while incorporating the same in control information.

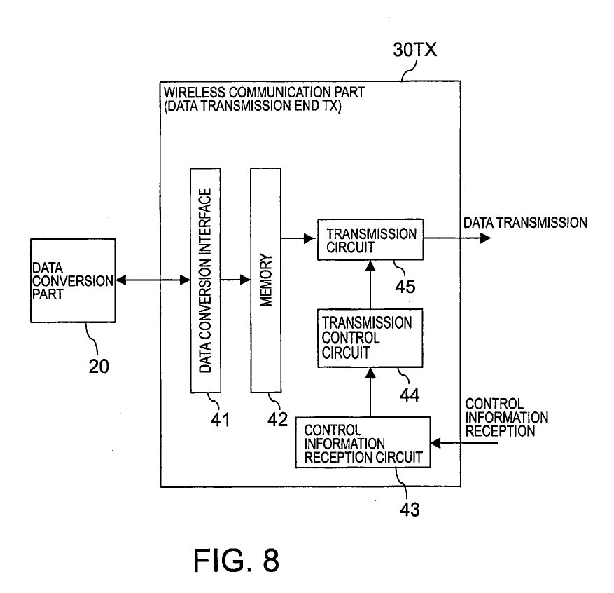

In the present embodiment, a data transmitter having the same configuration as the prior art example shown in FIG. 8 is used for the data transmitting part of the wireless apparatus.

Accordingly, when correct block data cannot be received at the data receiving end even when a predetermined number of times, or the maximum number of retransmissions is reached, an ACK signal is transmitted to the data transmitting end for other block data containing only packet data contained in the block data, regardless of whether the reception was successful or not. This eliminates the retransmission of the data from the wireless apparatus at the other end, resulting in improvement in the transmission efficiency.

A second embodiment of the present invention will now be described.

In the first embodiment, when correct block data cannot be received even when the maximum number of retransmissions is reached, the packet composition part 24 stores the block data and extracts packet numbers of packets contained in the block data from the block data to store the same. If block data subsequently received contains only packets of the same numbers as those stored previously, an ACK signal is transmitted to the data transmitting end in response to the reception of the block data, regardless of whether the reception was successful or not. In contrast, according to the second embodiment, when correct block data cannot be received even when the maximum number of retransmissions is reached, packet numbers of packets contained in the block data are extracted from the block data. The packet numbers are transmitted to the data transmitting end while being incorporated in control information, so that control is performed to stop transmission of the block data containing only packets of the same packet numbers from among block data to be subsequently transmitted from the data transmitting end.

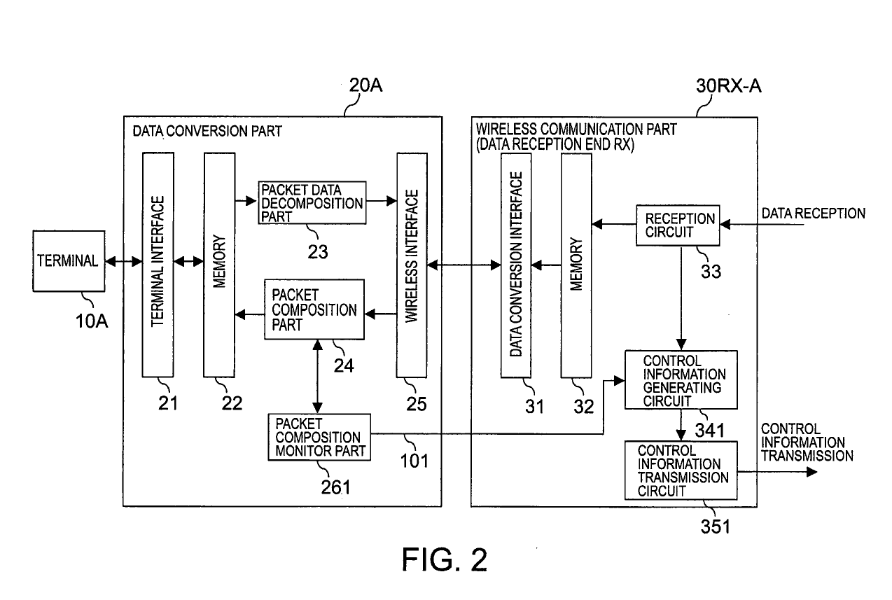

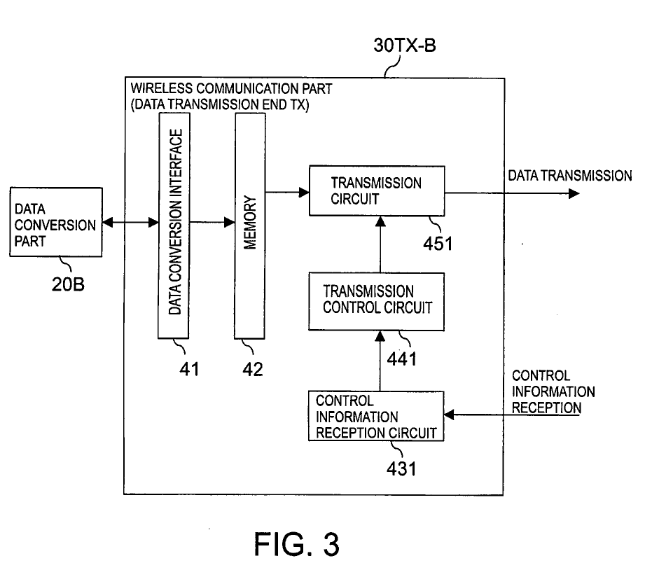

FIG. 2 is a block diagram of a data receiving end and FIG. 3 is a block diagram of a data transmitting end according to the second embodiment. The data conversion part 20A shown in FIG. 2 and the data reception part of the wireless communication part are formally the same as those in the configuration block diagram shown in FIG. 1. FIG. 2 is substantially different from FIG. 1 in that a packet composition monitor part 261, a control information circuit 341 and a control information transmission circuit 351 in FIG. 2 have functions somewhat different from those of the counterparts in FIG. 1. Therefore, the other blocks are assigned with the same reference numerals as those in FIG. 1 and description thereof will be omitted. The following description will be made principally on the differences.

In FIG. 2, the packet composition monitor part 261 detects that the packet composition part 24 cannot receive correct block data even when the maximum number of retransmissions is reached, and notifies packet data number information 101 contained in the block data to the control information generating circuit 341 in the data reception part 30RX-A of the wireless communication part.

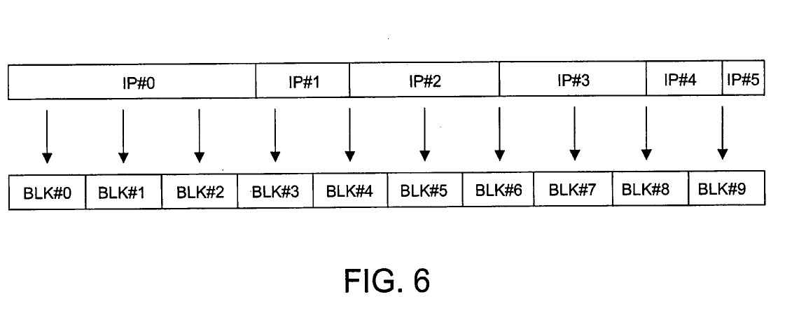

Referring to FIG. 6 again, sequential numbers are assigned to respective block data. Information on packet numbers, packet data starting positions and ending positions, and lengths of the packets included in the respective blocks are also assigned thereto. These information are embedded as a header in each block data. Upon reception of data, the packet composition part 24 receives, together with the block data, information on the packet numbers, packet data starting positions and ending positions, and lengths of the packets required for composition of packet data, and compose the packet data from normally received block data, based on these information. The packets thus composed are stored in the memory 22. The packet data numbers contained in the block data are notified to the packet composition monitor part 261.

As described above, the block data which could not be received normally even upon reaching the maximum number of retransmissions cannot be composed as packet data. Therefore, information indicating that the composition was not possible is notified to the packet composition monitor part 261 together with the packet data numbers contained in the block data. In response to the notification indicating that the block data could not be received normally even upon reaching the maximum number of retransmissions and the notification of the packet numbers contained in the block, the packet composition monitor part 261 sends the notification to the control information generating circuit 341.

The control information generating circuit 341 in the data reception part 30RX-A of the wireless communication part determines whether or not the received block data has been received correctly, and generates an ACK signal if it is determined that the reception was correct, whereas generates an NACK signal if the reception was not correct. Further, if the information of packet data number 101 for which the packet composition is not possible is notified by the packet composition monitor part 261, this information is also included in the control information. The control information transmission circuit 351 transmits the ACK/NACK signal generated by the control information generating circuit 34, while incorporating the same in the control information, to the wireless apparatus at the other end (in FIGS. 2 to 4, the data transmitting end and the data receiving end are differentiated from each other by designating the wireless apparatus in FIG. 2 by A while designating the wireless apparatus at the other end by B).

FIG. 3 is a block diagram showing a data transmission part 30TX-B in the wireless communication part at the data transmitting end B according to the second embodiment. The configuration shown in FIG. 3 is similar to that of FIG. 8, whereas some of the components have somewhat different functions. Those components having somewhat different functions are assigned with different reference numerals. The following description will be made principally on the parts having different functions. A control information reception circuit 431 receives control information transmitted from the wireless apparatus at the other end A shown in FIG. 2. Upon receiving an ACK/NACK signal contained in the control information, a transmission control circuit 441 gives an instruction to a transmission circuit 451 to transmit a new block data if the received signal is an ACK signal. If the received signal is an NACK signal, the transmission control circuit 441 gives an instruction to the transmission circuit 451 to retransmit corresponding block data.

Upon receiving the number of the packet which cannot be composed from the control information reception circuit 431, the transmission control circuit 441 notifies this packet number to the transmission circuit 451. The transmission circuit 451 holds the number. According to the instruction from the transmission control circuit 441, the transmission circuit 451 either transmits a new block data or retransmits a block data. If a block data contains only packet data that cannot be composed, the block data will not be transmitted. When the subsequent block is a block belonging to the next packet, the block is transmitted to the receiving end similarly to the prior art.

In this manner, the block data containing only packet data that cannot be composed is prevented from being transmitted, enabling the improvement of the transmission efficiency. Additionally, the receiving end does not have to demodulate the block which is not transmitted thereto, and thus is saved from unnecessary consumption of power.

A description will now be made a third embodiment of the present invention.

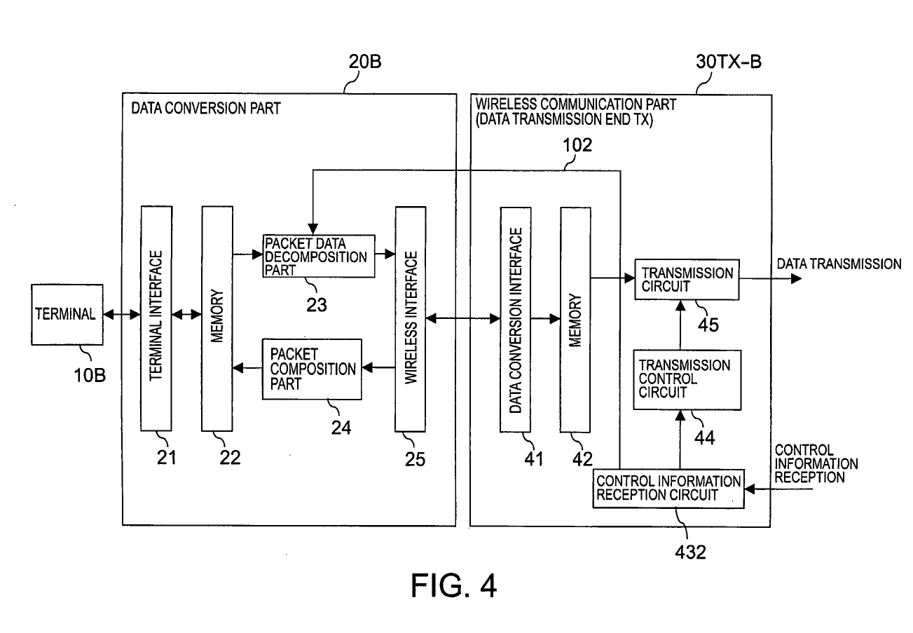

A data conversion part and a data reception part of a wireless communication part at the data receiving end A according to the third embodiment are the same as those shown in FIG. 2 for the second embodiment. Therefore, the description thereof will be omitted. A data conversion part and the data transmission (TX) end of a wireless communication part at the data transmitting end B will be described with reference to FIG. 4. In FIG. 4, similar parts and components to those in FIG. 2 are assigned with same reference numerals.

Referring to FIG. 4, a control information reception circuit 432 receives control information from the data receiving end A. Similarly to the second embodiment, this control information contains not only an ACK/NACK signal but also a number of packet data which cannot be composed. Upon receiving an ACK/NACK signal from the control information reception circuit 432, a transmission control circuit 441 gives an instruction to the transmission circuit 45 to transmit a new block data if the received signal is an ACK, whereas gives an instruction to the transmission circuit 45 to retransmit corresponding block data if the received signal is an NACK. When receiving the number of packet data that cannot be composed, the control information reception circuit 432 notifies the packet data number 102 to the packet data decomposition part 231 of the data conversion part 20B.

The packet data decomposition part 231 of the data conversion part 20B divides packet data stored in the memory 22 into a plurality of block data as shown in FIG. 6. When notified by the control information reception circuit 432 of the packet data number 102 for which composition is not possible, the packet data decomposition part 231 will perform packet division processing while discarding the packet data of the packet data number. This inhibits the transmission of packet data that cannot be composed into packet data, and thus possibly improves the transmission efficiency.

In the second and third embodiments described above, the packet composition monitor part 261 in the data conversion part 20A at the data receiving end (A) generates a number of packet data for which data composition is not possible and transmits the control information to the data transmitting end (B). Alternatively, it is also possible to transmit a number of block data that cannot compose packet data, instead of transmitting a number of packet data that cannot compose data.

Specifically, the packet composition monitor part 261 acquires a number of block data that cannot be received correctly by the packet composition part 24 even when the maximum number of retransmissions is reached and notifies the number to the other end B via the data reception part 30RX-A of the wireless communication part. Receiving the notification of the block data number, the other end B (see FIG. 4) either do not transmit block data corresponding this block data number (according to the second embodiment), or finds a packet number contained in the block data corresponding to the block data number and performs packet division while discarding the packet data of the packet data number (according to the third embodiment).

In the embodiments described above, the wireless communication part of course includes a transmitting/receiving function to enable bidirectional data notification between the terminals 10A and 10B.

Although the embodiments above have been described for the case in which information required for packet composition is incorporated in the header of a block, such information may be transmitted through a separate channel from the block including the packet data. Based on the packet number extracted from the information transmitted through the separate channel, control may be performed so that, when a block data cannot be received even upon reaching the maximum number of transmissions, transmission of block data including only the same packet data as the packet data included in that block data is inhibited.

### INDUSTRIAL APPLICABILITY

The present invention is effective to inhibit unnecessary retransmission of block data and to improve the transmission efficiency, when applied to a data retransmission method in which block data is retransmitted when receiving an NACK signal as a response signal (ACK/NACK) from the receiving end to the block data transmitted by the transmitting end. Accordingly, the present invention is applicable to a data communication system, particularly to a data communication system utilizing a wireless circuit.

1. A wireless communication system in which a transmitting end transmits packet data in block units; a receiving end transmits, to the transmitting end, a reception acknowledge signal when receiving the data successfully, whereas transmitting a negative acknowledge signal when not so; and the transmitting end retransmits data based on the negative acknowledge signal, the wireless communication system being characterized by comprising, at the receiving end thereof:
monitoring means for detecting that correct block data cannot be received even when a predetermined number of retransmissions of the block data is reached; and
means for transmitting a reception acknowledge signal for other block data containing, as packet data, only packet data that belongs to the same packet as the packet contained in the block data detected by the monitoring means.

2. A wireless communication system in which a transmitting end transmits packet data in block units; a receiving end transmits, to the transmitting end, a reception acknowledge signal when receiving the data successfully, whereas transmitting a negative acknowledge signal when not so; and the transmitting end retransmits data based on the negative acknowledge signal, the wireless communication system being characterized by comprising:
at the receiving end thereof, means for detecting that correct block data cannot be received even when a predetermined number of retransmissions of the block data is reached and giving a notification to that effect to the transmitting end; and
at the transmitting end, transmission control means for performing control to inhibit transmission of block data containing, as packet data, only packet data that belongs to the same packet as that contained in the block data, in response to the notification.

3. The wireless communication system according to claim 2, characterized in that the transmission control means discards the packet data contained in the block data.

4. The wireless communication system according to claim 3, characterized in that the notification contains a number of the block data or a number of packet data contained in the block data, and the transmission control means controls the block data transmission based on the block data number or the packet data number.

5. A data retransmission control method for a wireless communication system in which a transmitting end transmits packet data in block units; a receiving end transmits, to the transmitting end, a reception acknowledge signal when receiving the data successfully, whereas transmitting a negative acknowledge signal when not so; and the transmitting end retransmits data based on the negative acknowledge signal, the data retransmission control method being characterized by comprising, at the receiving end:
a monitoring step of detecting that correct block data cannot be received even when a predetermined number of retransmissions of the block data is reached; and
a step of transmitting a reception acknowledge signal for other block data containing, as packet data, only packet data that belongs to the same packet as the packet contained in the block data detected by the monitoring means.

6. A data retransmission control method for a wireless communication system in which a transmitting end transmits packet data in block units; a receiving end transmits, to the transmitting end, a reception acknowledge signal when receiving the data successfully, whereas transmitting a negative acknowledge signal when not so; and the transmitting end retransmits data based on the negative acknowledge signal, the data retransmission control method being characterized by comprising:
at the receiving end, a step of detecting that correct block data cannot be received even when a predetermined number of retransmissions of the block data is reached and giving a notification to that effect to the transmitting end; and
at the transmitting end, a transmission control step of performing control to inhibit transmission of block data containing, as packet data, only packet data that belongs to the same packet as that contained in the block data, in response to the notification.

7. The data retransmission control method according to claim 6, characterized in that the transmission control step discards the packet data contained in the block data.

8. The data retransmission control method according to claim 7, characterized in that the notification contains a number of the block data or a number of packet data contained in the block data, and the transmission control step controls the block data transmission based on the block data number or the packet data number.

9. A wireless receiving apparatus which transmits, to a transmitting end, a reception acknowledge signal when block data transmitted by the transmitting end while dividing packet data into blocks is received successfully, whereas, when not so, transmits a negative acknowledge signal to receive retransmission of the data from the transmitting end based on the negative acknowledge signal, the wireless receiving apparatus being characterized by comprising:
monitoring means monitoring means for detecting that correct block data cannot be received even when a predetermined number of retransmissions of the block data is reached; and
means for transmitting a reception acknowledge signal for other block data containing, as packet data, only packet data that belongs to the same packet as the packet contained in the block data detected by the monitoring means.

10. A wireless receiving apparatus which transmits, to a transmitting end, a reception acknowledge signal when block data transmitted by the transmitting end while dividing packet data into blocks is received successfully, whereas, when not so, transmits a negative acknowledge signal to receive retransmission of the data from the transmitting end based on the negative acknowledge signal, the wireless receiving apparatus being characterized by comprising:
means for detecting that correct block data cannot be received even when a predetermined number of retransmissions of the block data is reached and giving a notification to that effect to the transmitting end.

11. A wireless transmitting apparatus which transmits packet data while dividing the same into blocks, and receives transmission of a reception acknowledge signal when the receiving end has successfully received the block data, whereas, when not so, receives a negative acknowledge signal and retransmits data based on the negative acknowledge signal, the wireless transmitting apparatus being characterized by comprising:
transmission control means which, when receiving from the receiving end a notification indicating that correct block data cannot be received even when a predetermined number of retransmissions of the block data is reached, performs control to inhibit transmission of block data containing, as packet data, only packet data that belongs to the same packet as that contained in the block data

12. The wireless transmitting apparatus according to claim 11, characterized in that the transmission control means discards the packet data contained in the block data.
